(19) United States
(12) Patent Application Publication
(10) Pub. No.: US 2014/0241149 A1
(43) Pub. Date: Aug. 28, 2014

(54) SYSTEMS AND METHODS FOR SYNCHRONIZING WIRELESS COMMUNICATION DEVICE CONFIGURATIONS

(71) Applicant: QUALCOMM INCORPORATED, San Diego, CA (US)

(72) Inventors: Zhengwei Liu, San Diego, CA (US); Xiaoxia Zhang, San Diego, CA (US); Magnus D. Kretz, San Diego, CA (US); Wanshi Chen, San Diego, CA (US)

(73) Assignee: QUALCOMM Incorporated, San Diego, CA (US)

(21) Appl. No.: 13/778,782

(22) Filed: Feb. 27, 2013

(51) Int. Cl. H04W 72/04

(52) U.S. Cl. CPC H04W 72/0413
USPC 370/228; 370/329; 370/336; 370/280

(57) ABSTRACT

An apparatus operable in a communication system is described. The apparatus includes means for sending a connection reconfiguration message using a first configuration. The apparatus also includes means for receiving an acknowledgement message using the first configuration. The apparatus also includes means for applying a second configuration as indicated in the acknowledgement message. The apparatus also includes means for sending a connection reconfiguration complete message uplink grant in a common search space. The apparatus also includes means for receiving a connection reconfiguration complete message using the second configuration.

### TECHNICAL FIELD

The present disclosure relates generally to electronic communications. More specifically, the present disclosure relates to systems and methods for synchronizing wireless communication device configurations.

### BACKGROUND

In the last several decades, the use of electronic devices has become common. In particular, advances in electronic technology have reduced the cost of increasingly complex and useful electronic devices. Cost reduction and consumer demand have proliferated the use of electronic devices such that they are practically ubiquitous in modern society. As the use of electronic devices has expanded, so has the demand for new and improved features of electronic devices. More specifically, electronic devices that perform functions faster, more efficiently or with higher quality are often sought after.

Some electronic devices (e.g., cellular phones, smartphones, computers, etc.) communicate with other electronic devices via a network. For example, a wireless communication device (e.g., cellular phone, smartphone, etc.) may wirelessly communicate with another wireless communication device via a wireless network. This may enable the wireless communication device to access and/or communicate voice, video, data and so on.

As wireless communication technology advances, additional releases of wireless communication standards (e.g., Long Term Evolution (LTE)) are generated to standardize the implementation of the advances. A wireless communication device and a base station may support multiple releases of the wireless communication standard. In this case, the wireless communication device and the base station may transition their configurations to correspond to a particular release. However, the transition period from one configuration to another configuration may differ between the wireless communication device and the base station, which may cause communication outages. As can be seen from this discussion, systems and methods that improve synchronization of wireless communication device configurations may be beneficial.

### BRIEF DESCRIPTION OF THE DRAWINGS

FIG. 1 is a block diagram illustrating one configuration of a user equipment (UE) and an evolved Node B (eNB) in which systems and methods for synchronizing wireless communication device configurations may be implemented;

FIG. 2 is a flow diagram illustrating one configuration of a method for synchronizing wireless communication device configurations;

FIG. 3 is a flow diagram illustrating another configuration of a method for synchronizing wireless communication device configurations;

FIG. 4 is a block diagram illustrating another configuration of a user equipment and an evolved Node B in which systems and methods for synchronizing wireless communication device configurations may be implemented;

FIG. 5 is a flow diagram illustrating another configuration of a method for synchronizing wireless communication device configurations;

FIG. 6 is a block diagram illustrating another configuration of a user equipment and an evolved Node B in which systems and methods for synchronizing wireless communication device configurations may be implemented;

FIG. 7 is a flow diagram illustrating another configuration of a method for synchronizing wireless communication device configurations;

FIG. 8 is a block diagram illustrating another configuration of a user equipment and an evolved Node B in which systems and methods for synchronizing wireless communication device configurations may be implemented;

FIG. 9 is a flow diagram illustrating another configuration of a method for synchronizing wireless communication device configurations;

FIG. 10 is a block diagram illustrating another configuration of a user equipment and an evolved Node B in which systems and methods for synchronizing wireless communication device configurations may be implemented;

FIG. 11 is a flow diagram illustrating another configuration of a method for synchronizing wireless communication device configurations;

FIG. 12 is a flow diagram illustrating another configuration of a method for synchronizing wireless communication device configurations;

FIG. 13 is a thread diagram illustrating another configuration of a user equipment and an evolved Node B in which systems and methods for synchronizing wireless communication device configurations may be implemented; and

FIG. 14 shows part of a hardware implementation of an apparatus for executing the functionality dynamic enablement methods described herein.

### DETAILED DESCRIPTION

The systems and methods disclosed herein describe wireless communication devices for synchronizing wireless communication device configurations. An evolved Node B (eNB) sends a connection reconfiguration message to a user equipment (UE) using a first configuration. The user equipment then responds with an acknowledgement message indicating receipt of the connection reconfiguration message. The acknowledgement message is sent in the first configuration. The evolved Node B and the user equipment apply the configuration (e.g., the second configuration) as described in the connection reconfiguration message. The evolved Node B then sends a connection reconfiguration complete message uplink grant to the user equipment. The user equipment responds with a connection reconfiguration complete message indicating the user equipment has applied the second configuration. The connection reconfiguration complete message may be sent using the second configuration. In this example, the evolved Node B and the user equipment may use features of the second configuration in wireless communications.

In the following description, for reasons of conciseness and clarity, terminology associated with the Long Term Evolution (LTE) standards, as promulgated under the 3rd Generation Partnership Project (3GPP) by the International Telecommunication Union (ITU), is used. It should be noted that the systems and methods disclosed herein are also applicable to other technologies, such as technologies and the associated standards related to Code Division Multiple Access (CDMA), Time Division Multiple Access (TDMA), Frequency Division Multiple Access (FDMA), Orthogonal Frequency Division Multiple Access (OFDMA) and so forth. Terminologies associated with different technologies can vary. For example, depending on the technology considered, a wireless communication device can sometimes be called a user equipment (UE), a mobile station, a mobile terminal, a subscriber unit, an access terminal, etc., to name just a few. Likewise, a base station can sometimes be called an access point, a Node B, an evolved Node B (eNB) and so forth. It should be noted that different terminologies apply to different technologies when applicable.

For a Long Term Evolution (LTE) release 10 (Rel-10) capable user equipment, a call setup may start in a Long Term Evolution (LTE) release 8 (Rel-8) state after random access. An evolved Node B may then query the user equipment's capability. If the user equipment is release 10 (Rel-10) capable, the evolved Node B may reconfigure the user equipment with release 10 (Rel-10) features. However, the user equipment's transition period and the evolved Node B's transition period may not be synchronized. For example, certain channels, such as a physical downlink shared channel (PDSCH), may not rate match around a channel state information reference signal (CSI-RS) if in a release 8 (Rel-8) state. The channel may rate match around a channel state information reference signal if in release 10 (Rel-10) state. Similarly, some new fields included in release 10 (Rel-10) may be interrupted in the downlink channel information (DCI), for example, an aperiodic sounding reference signal (AP-SRS) flag and/or a physical uplink shared channel (PUSCH) multi-cluster flag. Some of the release 10 (Rel-10) downlink channel information format changes may apply to a user equipment specific search space. In some configurations, Hetnet related dual channel quality information configuration in release 10 (Rel-10) may be interrupted. The misaligned transition period may cause a physical downlink shared channel failure. The misaligned transition may also corrupt the hybrid automatic repeat request (HARQ) and further soft combining. The present disclosure presents systems and methods on a user equipment side and a scheduler side to mitigate the impact. The present disclosure presents various solutions for mitigating a user equipment's transition from Long Term Evolution (LTE) release 8 (Rel-8) to Long Term Evolution (LTE) release 10 (Rel-10) to avoid downlink/uplink temporary outage due to an imperfectly aligned transition time between a user equipment and an evolved Node B.

During random access, an evolved Node B may assume a user equipment complies with Long Term Evolution (LTE) release 8 (Rel-8). After polling for a user equipment's capability, a release 10 (Rel-10) capable user equipment may be reconfigured with release 10 (Rel-10) capable features, such as transition mode nine (TM9), Hetnet, aperiodic sounding reference signal and/or carrier aggregation through an RRCConnectionReconfiguration message.

After a user equipment successfully receives an RRCConnectionReconfiguration message, the user equipment may apply the configuration to all layers right away. Once reconfiguration is complete at all layers, the user equipment may send an RRCConnectionReconfigurationComplete message using the new configuration. In some examples, the RRCConnectionReconfiguration may include uplink control information (UCI) (e.g., a dual channel quality indicator (CQI))/aperiodic sounding referencing signal (AP-SRS) and a channel state information reference signal (CSI-RS) reconfiguration). In other words a release 8 (Rel-8) to release 10 (Rel-10) state transition may include an RRCConnectionReconfiguration procedure.

In this implementation, a hybrid automatic repeat request level acknowledgement message (e.g., UL ACK) of an RRCConnectionReconfiguration, that may be sent four or more sub-frames later, may use the old configuration. Similarly, a radio link control (RLC) acknowledgement message (e.g., a physical uplink shared channel (PUSCH)) may be sent using an old configuration.

In some configurations, an evolved Node B's transition period may start when the evolved Node B sends an RRCConnectionReconfiguration message and may end when the evolved Node B receives an RRCConnectionReconfigurationComplete message. In some implementations, the duration of the evolved Node B's transition may be approximately 30 milliseconds for a good radio condition case and may be approximately 100 milliseconds for a bad radio condition case. In some implementations, the transition window may be big. A user equipment's transition period may start when the user equipment receives an RRCConnectionReconfiguration message and may end when the user equipment sends an RRCConnectionReconfigurationComplete message. In some implementations, the user equipment's transition window may be smaller than the evolved Node B's transition window.

In other words, there may be no unified user equipment/evolved Node B state transition/RRCReconfiguration time. For example, a user equipment may start a release 10 (Rel-10) state immediately after receiving an RRCConnectionReconfiguration message. Once it is complete, the user equipment may send an RRCConnectionReconfigurationComplete message in the new configuration. An evolved Node B may start RRCReconfiguration/release 10 (Rel-10) state immediately after knowing that the user equipment has successfully received the RRCConnectionReconfiguration message. However, Long Term Evolution (LTE) has not specified how to get an RRCConnectionReconfiguration message confirmation reliably during RRCReconfiguration period at any level (e.g., hybrid automatic repeat request level, radio link control level). An evolved Node B may be in the new configuration before the user equipment sends out the RRCConnectionReconfigurationComplete message, so the evolved Node B can receive the message correctly. An evolved Node B may know the user equipment has received the RRCConnectionReconfiguration message correctly; otherwise, the evolved Node B may re-transmit the signaling message using the old configuration. Furthermore, it is hard to synchronize other messages during this period that are sent using the old configuration or the new configuration. Sending these messages may be avoided. As described above, the time difference may be several milliseconds apart in a good radio condition case or tens of milliseconds apart in a bad radio condition case.

Some of the attributes that may be included in an RRCReconfiguration that may be jeopardized during a user equipment/evolved Node B reconfiguration are described as follows. A RadioResourceConfigDedicated attribute may include a PhysicalConfigDedicated attribute. The PhysicalConfigDedicated attribute may include an uplink control information configuration difference between the user equipment and the evolved Node B. The difference may cause the evolved Node B to not be able to receive an uplink control and a physical uplink shared channel due to an uplink multiplex difference. The RadioResourceConfigDedicated may also include a channel state information reference signal configuration difference between the user equipment and the evolved Node B. This difference may cause the user equipment to not be able to receive a physical downlink shared channel.

More details about the difference between release 8 (Rel-8) and release 10 (Rel-10) are given as follows. With regards to the physical downlink shared channel, in release 8 (Rel-8) a user equipment's physical downlink shared channel may not rate match around a channel state information reference signal. By comparison, in release 10 (Rel-10) a user equipment's physical downlink shared channel for all transmission modes may rate match around the channel state information reference signal (except when paging and when a physical downlink shared channel uses a temporary cell radio network temporary identifier (C-RNTI)).

Additionally, release 10's (Rel-10) downlink control information (DCI) format may add new attributes to the existing release 8 (Rel-8)/release nine (Rel-9) downlink control information format; such as an aperiodic sounding reference signal requirement, a physical uplink shared channel multi-cluster flag, etc., in most cases in a user equipment specific search space. Release 10 (Rel-10) also may add a couple of new downlink control information formats (e.g., format 2C and format 4). Release 10 (Rel-10) may also support dual channel quality indicators for Hetnet. Other release 10 (Rel-10) features may potentially become available, such as carrier aggregation, transmission mode 9, physical uplink shared channel multiple input and multiple output, multi-cluster, Hetnet, etc.

As described above, during the RRCConnectionReconfiguration transition period, the modified entities for different layers may be out of sync. This may result in outage at various layers. Additionally, during a user equipment release 8 (Rel-8)/release 10 (Rel-10) transition period, some existing attributes that are not backward compatible (e.g., physical downlink shared channel, downlink control information format and uplink (dual channel quality indicator) may be out of sync. New features and downlink control information formats may be fine since they are controlled by evolved Node B. These attributes may be started after release 10 (Rel-10) has been applied. However, for existing channels (e.g., existing physical downlink shared channels, downlink control information formats (e.g., downlink control information format 0) and physical uplink control channel/physical uplink shared channel (due to dual channel quality indicator)), there may be ambiguity during the release 10 (Rel-10) transition period. So the user equipment and the evolved Node B may be out of sync regarding whether the physical downlink shared channel should rate match around a channel state information reference signal or not, whether new release 10 (Rel-10) downlink control information attributes (such as an aperiodic sounding referencing signal request flag) will be accounted for and which per channel quality indicator opportunity to use. This lack of synchronicity may result in temporary user equipment/evolved Node B communication outages. The outage may not only corrupt a current sub-frame, but may also corrupt the whole hybrid automatic repeat request combining sequence since an out of sync assumption could corrupt the hybrid automatic repeat request symbols. By comparison, a synchronized user equipment state transition may mitigate communication outages between the user equipment and the evolved Node B during this period.

The systems and methods disclosed herein may enhance physical downlink shared channel performance, physical uplink control channel/physical uplink shared channel performance, downlink control information interpretation accuracy during a user equipment's release 8 (Rel-8) to release 10 (Rel-10) state transition and RRCConnectionReconfiguration for non hand-over (HO) mode in general by using the following techniques. For example, a release 10 (Rel-10) capable evolved Node B may support release 8 (Rel-8) user equipments, release 10 (Rel-10) user equipments and a user equipment during a release 8 (Rel-8) to release 10 (Rel-10) transition.

An example is described as follows. Regarding an evolved Node B, after a RRCConnectionReconfiguration message is sent using an old configuration for a non hand-over case (not including mobilityControlInfo), the evolved Node B may have a reliable way of detecting that a user equipment has received the message successfully. The evolved Node B may then apply the new configuration internally. The evolved Node B may also receive a user equipment's RRCConnectionReconfigurationComplete message in the new configuration. In some configurations, the evolved Node B may stop sending any user equipment specific grants and may discard user equipment specific data from the user equipment during this period. In other words there may be no downlink or uplink grants, the first grant may be the uplink grant sent in a common search space for the RRCConnectionReconfigurationComplete message.

After receiving the RRCConnectionReconfiguration message, the user equipment may either send a physical (PHY)/hybrid automatic repeat request level uplink acknowledgement message for the message in the old configuration or a radio link control level acknowledgement message in the old configuration before it sends the RRCConnectionReconfigurationComplete message in the new configuration. A few sub-frames (e.g., 1-2 milliseconds) guard time may be inserted in between if the evolved Node B needs time to apply the reconfiguration. At the physical layer, the user equipment may specify the uplink acknowledgement message corresponding to the transport block carrying the RRCConnectionReconfiguration message sent using the old configuration. Alternatively, at a radio link control layer, the user equipment may specify an RRCConnectionReconfiguration's acknowledgement mode (AM) using the old configuration.

In some configurations, if an evolved Node B still sends a downlink grant, the user equipment may apply the new configuration (e.g., release 10 (Rel-10)) after receiving the RRCConnectionReconfiguration message. The user equipment may then smart-hybrid automatic repeat request combine afterwards until the user equipment sends out the RRCConnectionReconfigurationComplete message. If an evolved Node B still sends an uplink grant and there are uplink control information configuration changes, the user equipment may use the old configuration to send out uplinks before hybrid automatic repeat request/radio link control level acknowledgement messages. The user equipment may use the new configuration to send out uplinks after the RRCConnectionReconfigurationComplete message. The uplink transmission during the guard time may be unspecified.

In some implementations, an activation time may be defined. Since there is no activation time in the RRCConnectionReconfiguration message or the RRCConnectionReconfigurationComplete message, it may be assumed that a user equipment state transition on both the user equipment and the evolved Node B happens after a certain amount of time (e.g., 8 milliseconds) after the RRCConnectionReconfiguration message is sent successfully over the air. This time period may be frequency-division duplexing (FDD)/time-division duplexing (TDD) configuration dependent. The activation time may be indicated in the RRCConnectionReconfiguration message.

In some implementations, a new media access control header control element, or similar method (e.g., Activate SCell) may indicate that the new configuration (e.g., release 10 (Rel-10)) has initiated. In some implementations, the RRCConnectionReconfiguration message may not be fragmented into multiple transport blocks. In some implementations, a special downlink control indicator (at a physical layer) may indicate the new configuration (e.g., release 10 (Rel-10)) state start time.

As described above, the evolved Node B may pack a RRCConnectionReconfiguration message into a media access control packet (e.g., one transport block). At least one evolved Node B lower layer may track this packet's acknowledgement message. After the user equipment receives the RRCConnectionReconfiguration message successfully, the user equipment may make sure that the corresponding uplink acknowledgement message is sent using the old configuration. In some implementations, hybrid automatic repeat requests may be terminated. The user equipment may then switch to a new configuration. Similarly, the evolved Node B may switch to the new configuration after receiving the uplink acknowledgement for the RRCConnectionReconfiguration message. Once the user equipment is ready, the evolved Node B may send an uplink grant to the user equipment for the RRCConnectionReconfigurationComplete message.

When the user equipment gets the uplink grant for the RRCConnectionReconfigurationComplete message, it may be in the new configuration, and may send an RRCConnectionReconfigurationComplete message in the new configuration. In this implementation, the evolved node B may not send any downlink/uplink grant to the user equipment between the RRCConnectionReconfiguration message and the RRCConnectionReconfigurationComplete message to avoid misalignment. Additionally, the evolved Node B may use a common search space and may not use release 10 (Rel-10) downlink control information format during the evolved Node B release 10 (Rel-10) transition period. The evolved Node B may set up semi-persistent scheduling after the user equipment has moved to a release 10 (Rel-10) state. The evolved Node B may reduce uplink control information configuration changes. According to this implementation, there may be a faster transition period (e.g., a couple of milliseconds in a scenario, and no radio resource control signaling re-transmission) and it may be easy to implement.

In some implementations, the user equipment may send a radio link control acknowledgement message (e.g., as compared to a physical layer uplink acknowledgement message). In this implementation, the transmission time may be slower due to a slow radio link control acknowledgement message (e.g., refer to SRB1 configuration in 36.331, sec 9.2.1.1). This implementation may be easier to implement. For example, there may be no special case for multi-layer radio resource control message tracking.

In some implementations, a user equipment may start release 10 (Rel-10) mode (e.g., a user equipment does not rate match around a channel state information reference signal) immediately after receiving the RRCConnectionReconfiguration message. Then, for a sub-frame without a channel state information reference signal, the user equipment may do business as usual. For a sub-frame having a channel state information reference signal, if a physical downlink shared channel cyclic redundancy check passes, the user equipment may confirm it is in release 10 (Rel-10) state. If the physical downlink shared channel cyclic redundancy check fails, the user equipment may throw the message away (e.g., not use it in soft combining since it might corrupt the log-likelihood ratios (LLR) for re-transmission) or do hypothesis (e.g., use it as soft-combining, and not use it as soft-combining). The user equipment may do the above operation until the user equipment sends out the RRCConnectionReconfigurationComplete message.

The systems and methods disclosed herein may define a release 10 (Rel-10) state transition activation time (e.g., two milliseconds) after the RRCConnectionReconfiguration message is successfully sent over the air. This activation time may be frequency-division duplexing/time-division duplexing configuration dependent. The activation time may be included in the RRCConnectionReconfiguration message. In this implementation, the transition period ambiguity may be removed.

A media access control header control element may trigger a release 10 (Rel-10) state indication. For example, after an evolved Node B receives an RRCConnectionReconfigurationComplete message, it may send a release 10 (Rel-10) activation media access control element in a physical downlink shared channel. In some implementations, the evolved Node B may apply release 10 (REL-10) (e.g., rate matching around a channel state information reference signal) similar to SCell activation. In this implementation, the transition period ambiguity may be removed. Transition time may also be reduced as the media access control layer turnaround is faster than the radio resource control layer. The evolved Node B may use a similar method as another RRCConnectionReconfiguration element, and activate SCell for carrier aggregation.

In some implementations a special downlink control indicator may indicate release 10 (Rel-10) state has started. This implementation may reduce the transition period because the physical layer turnaround is faster than the media access control/radio resource control layer.

Various configurations are now described with reference to the Figures, where like reference numbers may indicate functionally similar elements. The systems and methods as generally described and illustrated in the Figures herein could be arranged and designed in a wide variety of different configurations. Thus, the following more detailed description of several configurations, as represented in the Figures, is not intended to limit scope, as claimed, but is merely representative of the systems and methods.

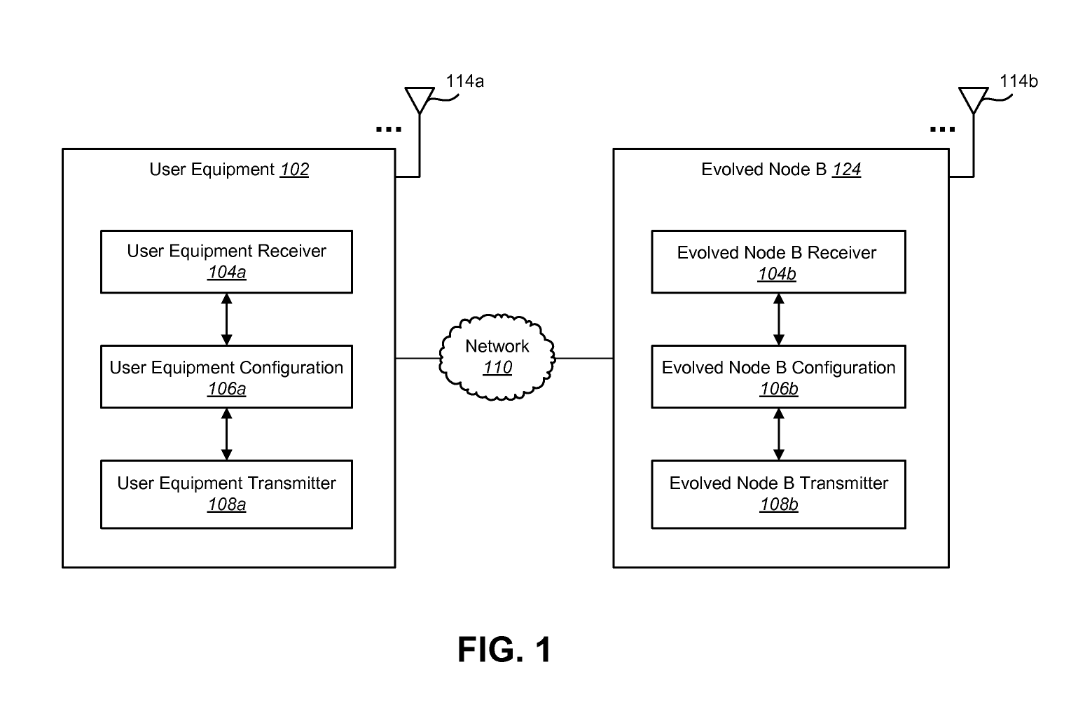

FIG. 1 is a block diagram illustrating one configuration of a user equipment 102 and an evolved Node B 124 in which systems and methods for synchronizing wireless communication device configurations may be implemented. In some implementations, the user equipment 102 may also be referred to as, and may include some or all of the functionality of, a terminal, an access terminal, a subscriber unit, a station, etc. The term “user equipment” will be used herein. Examples of user equipments 102 may include a cellular phone, a personal digital assistant (PDA), a wireless device, a wireless modem, a handheld device, a laptop computer, a session initiation protocol phone, a wireless local loop (WLL) station, etc.

In some implementations, an evolved Node B 124 may be a base station. A base station may be a station that communicates with one or more wireless communication devices. An evolved Node B 124 may also be referred to as, and may include some or all of the functionality of, an access point, a broadcast transmitter, a Node B, etc. The term “evolved Node B” will be used herein. Each evolved Node B 124 provides communication coverage for a particular geographic area. An evolved Node B 124 may provide communication coverage for one or more user equipments. The term “cell” can refer to an evolved Node B 124 and/or its coverage area depending on the context in which the term is used. It should be noted that an evolved Node B 124 may communicate with one or more user equipments 102 that are within a cell or sector coverage area. For example, a cell or sector is a geographical area serviced by an evolved Node B 124. A single evolved Node B 124 may provide one or more cells or sectors for communication. For example, an evolved Node B 124 may provide three sectors for communication with the user equipment 102. As used herein, the term “cell” may be used to refer to a cell and/or a sector.

The user equipment 102 and the evolved Node B 124 may communicate with each other via a radio access network 110. For example, the user equipment 102 and the evolved Node B 124 may each include a receiver 104a-b, a transmitter 108a-b and one or more antennas 114a-b for receiving information and/or for transmitting information. For instance, the user equipment 102 and the evolved Node B 124 may transmit electromagnetic signals to and receive electromagnetic signals from other communication devices. The receivers 104a-b and/or transmitters 108a-b may be used to receive/transmit electromagnetic signals (using one or more antennas 114a-b, for example). For instance, the user equipment 102 may communicate with the evolved Node B 124, using wireless (e.g., “over-the-air” (OTA)) signaling.

It should be noted that the term “apparatus” may be used herein to refer to a base station, a wireless communication device and/or other device. It should also be noted that a “communication system” may include one or more of a base station, a wireless communication device and other device(s).

In some implementations, the user equipment receiver 104a may receive messages to establish a call. The user equipment 102 may receive a message using a standard. For example, the user equipment 102 may receive a message using the Long Term Evolution (LTE) standard. More particularly, the user equipment receiver 104a may receive a message using a particular release of a standard. For example, the user equipment 102 may receive a message using release ten (Rel-10) of the Long Term Evolution (LTE) standard. In some implementations, the user equipment receiver 104a may be capable of receiving messages using different releases. In other words, the user equipment receiver 104a may receive a message using release 8 (Rel-8) and/or release ten (Rel-10) of the Long Term Evolution (LTE) standard. As will be described in detail below, the user equipment 102 may alter its configuration to conform to a particular release of a standard. The user equipment receiver 104a may also avoid receiving a message from other wireless communication devices.

Similarly, the evolved Node B receiver 104b may receive messages to establish a call. The evolved Node B 124 may receive a message using a standard. For example, the evolved Node B 124 may receive a message using the Long Term Evolution (LTE) standard. More particularly, the evolved Node B receiver 104b may receive a message using a particular release of a standard. For example, the evolved Node B 124 may receive a message using release ten (Rel-10) of the Long Term Evolution (LTE) standard. In some implementations, the evolved Node B receiver 104b may be capable of receiving messages using different releases. In other words, the evolved Node B receiver 104b may receive a message using release 8 (Rel-8) and/or release ten (Rel-10) of the Long Term Evolution (LTE) standard. As will be described in detail below, the evolved Node B 124 may alter its configuration to conform to a particular release of a standard. The evolved Node B receiver 104b may also avoid receiving a message from other wireless communication devices.

In some implementations, the evolved Node B transmitter 108b may send messages that establish a call. The evolved Node B transmitter 108b may send a message using a standard. For example, evolved Node B 124 may send a message using the Long Term Evolution (LTE) standard. More particularly, the evolved Node B transmitter 108b may send a message using a particular release of a standard. For example, evolved Node B 124 may send a message using release ten (Rel-10) of the Long Term Evolution (LTE) standard. In some implementations, the evolved Node B transmitter 108b may be capable of sending messages using different releases. In other words, the evolved Node B transmitter 108b may send a message using release 8 (Rel-8) and/or release ten (Rel-10) of the Long Term Evolution (LTE) standard. As will be described in detail below, the evolved Node B 124 may alter its configuration to conform to a particular release of a standard. The evolved Node B transmitter 108b may also avoid sending a message to another wireless communication device. For example, the evolved Node B transmitter 108b may avoid sending any transmission grants to the user equipment 102 between sending the connection reconfiguration message and receiving the connection reconfiguration complete message.

Similarly, the user equipment transmitter 108a may send messages that establish a call. The user equipment transmitter 108a may send a message using a standard. For example, the user equipment 102 may send a message using the Long Term Evolution (LTE) standard. More particularly, the user equipment transmitter 108a may send a message using a particular release of a standard. For example, the user equipment 102 may send a message using release ten (Rel-10) of the Long Term Evolution (LTE) standard. In some implementations, the user equipment transmitter 108a may be capable of sending messages using different releases. In other words, the user equipment transmitter 108a may send a message using release 8 (Rel-8) and/or release ten (Rel-10) of the Long Term Evolution (LTE) standard. As will be described in detail below, the user equipment 102 may alter its configuration to conform to a particular release of a standard. The user equipment transmitter 108a may also avoid sending a message to another wireless communication device.

The user equipment 102 may include a user equipment configuration block/module 106a. As used herein, the phrase “block/module” indicates that a particular component may be implemented in hardware, software or a combination of both. For example, the user equipment configuration block/module 106a-b may be implemented with hardware components such as circuitry and/or software components such as instructions or code, etc.

The user equipment configuration block/module 106a may apply a configuration to the user equipment 102. The user equipment configuration block/module 106a may be coupled to the user equipment receiver 104a and/or the user equipment transmitter 108a. In this implementation, the user equipment receiver 104a and the user equipment transmitter 108a may receive and/or transmit using the configuration applied by the user equipment configuration block/module 106a. For example, the user equipment configuration block/module 106a may apply a configuration to the user equipment 102 that complies with release 10 (Rel-10). In this example, the user equipment receiver 104a and the user equipment transmitter 108a may receive and/or transmit using release 10 (Rel-10).

In some implementations, the user equipment configuration block/module 106a may apply a configuration as indicated in a received message. For example, the user equipment configuration block/module 106a may apply the configuration indicated in the connection reconfiguration message. For example, the user equipment configuration block/module 106a may apply a configuration that complies with release 10 (Rel-10) using the information contained in a connection reconfiguration message.

Similarly, the evolved Node B 124 may include an evolved Node B configuration block/module 106b. The evolved B configuration block/module 106b may apply a configuration to the evolved Node B 124. The evolved Node B configuration block/module 106b may be coupled to the evolved Node B receiver 104b and/or the evolved Node B transmitter 108b. In this implementation, the evolved Node B receiver 104b and the evolved Node B transmitter 108b may receive and/or transmit using the configuration applied by the evolved Node B configuration block/module 106b. For example, the evolved Node B configuration block/module 106b may apply a configuration to the evolved Node B 124 that complies with release 10 (Rel-10). In this example, the evolved Node B receiver 104b and the evolved Node B transmitter 108b may receive and/or transmit using release 10 (Rel-10).

In some implementations, the user equipment configuration block/module 106a may apply a configuration indicated in a received message. For example, the evolved Node B configuration block/module 106b may apply the configuration indicated in an acknowledgement message. For example, the evolved Node B configuration block/module 106b may apply a configuration that complies with release 10 (Rel-10) as indicated in the acknowledgement message (e.g., the acknowledgement message that indicates the user equipment 102 has received a connection reconfiguration message).

Additionally or alternatively, the evolved Node B configuration block/module 106b may avoid applying a configuration to the evolved Node B 124. For example, the evolved Node B configuration block/module 106b may avoid applying a configuration to the evolved Node B 124 for the period between sending the connection reconfiguration message and receiving the connection reconfiguration complete message.

In some cases, applying the configuration may not be instantaneous. Examples of features that may be applied by the user equipment configuration block/module 106a include, but are not limited to, uplink control information configuration, channel state information reference signal configuration, media access control configuration, data radio bearer/signal radio bearer configuration, semi-persistent scheduling (SPS) configuration, carrier aggregation configuration, channel state information reference signal configuration, downlink control information format, transmission mode nine, physical uplink shared channel multi-cluster, physical uplink shared channel configuration, physical downlink shared channel configuration and physical uplink control channel configuration.

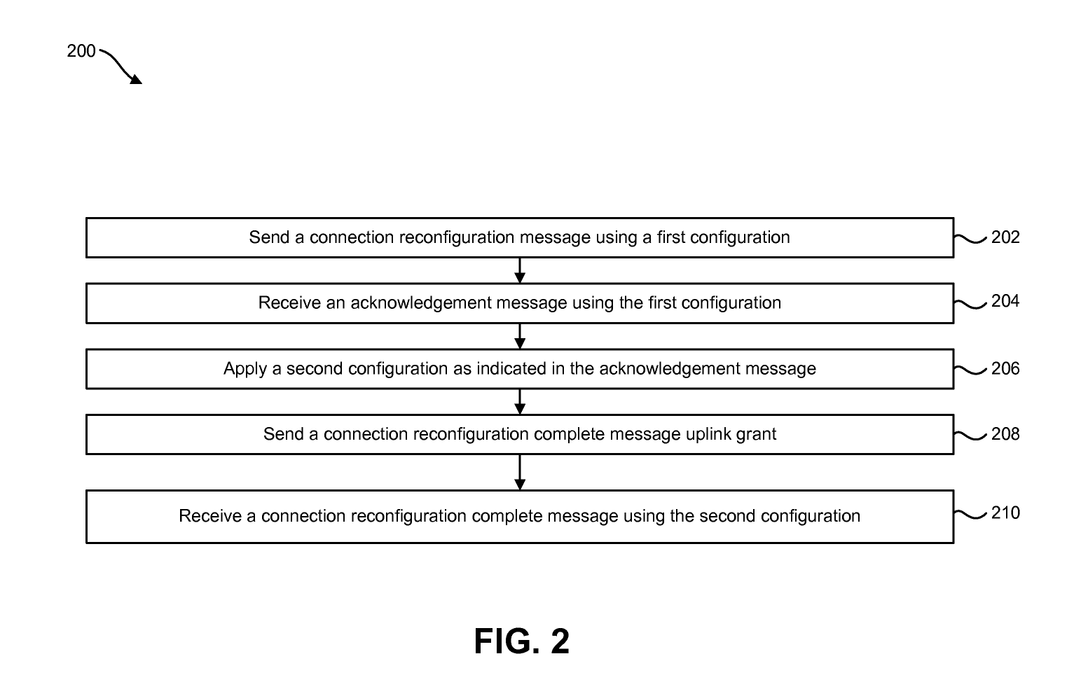

FIG. 2 is a flow diagram illustrating one configuration of a method 200 for synchronizing wireless communication device configurations. The method 200 may be performed by the evolved Node B 124. The evolved Node B transmitter 108b may send 202 a connection reconfiguration message using a first configuration. For example, the evolved Node B transmitter 108b may send 202 a connection reconfiguration message (e.g., an RRCConnectionReconfiguration message) to the user equipment 102.

The connection reconfiguration message may direct the user equipment 102 to apply a configuration that complies with a particular release of a wireless communication standard. In some implementations, the configuration (e.g., the second configuration) that the connection reconfiguration message indicates may be different from the current configuration of the user equipment 102 (e.g., the first configuration). An example is given as follows. The user equipment 102 may be configured using release 8 (Rel-8) of the Long Term Evolution (LTE) standard. The connection reconfiguration message may direct the user equipment 102 to apply a release 10 (Rel-10) configuration (e.g., rate matching around a channel state information reference signal). The connection reconfiguration message may be transmitted/received using release 8 (Rel-8).

Examples of features of a configuration that the connection reconfiguration message may direct the user equipment 102 to alter include uplink control information configuration, channel state information reference signal configuration, media access control configuration, data radio bearer/signal radio bearer configuration, semi-persistent scheduling (SPS) configuration, carrier aggregation configuration, channel state information reference signal configuration, downlink control information format, transmission mode nine, physical uplink shared channel multi-cluster, physical uplink shared channel configuration, physical downlink shared channel configuration and physical uplink downlink control channel configuration. In some implementations, the evolved Node B transmitter 108b may pack the connection reconfiguration message into a media access control packet. That is, the connection reconfiguration message may be included in one transport block. In this example, the evolved Node B 124 may track a media access control packet acknowledgement message. In some implementations, the evolved Node B 124 may track the acknowledgement message corresponding to the media access control packet at a lower layer (e.g., physical layer) of the evolved Node B 124.

The evolved Node B receiver 104b may receive 204 an acknowledgement message using the first configuration. The acknowledgement message may indicate that the user equipment 102 has received a message. For example, the evolved Node B receiver 104b may receive an acknowledgement message indicating that the user equipment 102 has received the connection reconfiguration message. In some implementations, the evolved Node B 124 may receive a message using a particular release of a standard. For example, if the user equipment 102 is using release 8 (Rel-8) and receives the connection reconfiguration message in a configuration using release 8 (Rel-8), the evolved Node B receiver 104b may receive the acknowledgement message using release 8.

The evolved Node B receiver 104b may receive the acknowledgement message at one or more layers of the evolved Node B 124. For example, the evolved Node B receiver 104b may receive a physical layer acknowledgement message (e.g., a hybrid automatic repeat request acknowledgement message). Similarly, the evolved Node B receiver 104b may receive a radio link control layer acknowledgement message.

The evolved Node B configuration block/module 106b may apply 206 a second configuration as indicated in the acknowledgement message. For example, the evolved Node B configuration block/module 106b may apply 206 a second configuration when it has received an acknowledgement message from the user equipment 102 indicating that the user equipment 102 has received the connection reconfiguration message. In this example, the evolved Node B configuration block/module 106b may apply the configuration indicated in the connection reconfiguration message. In some implementations, the second configuration may be release 10 (Rel-10).

Applying 206 a second configuration may include receiving and/or transmitting using the second configuration. For example, the evolved Node B receiver 104b and the evolved Node B transmitter 108b may receive and/or transmit using the configuration applied by the evolved Node B configuration block/module 106b. For example, the evolved Node B configuration block/module 106b may apply a configuration to the evolved Node B 124 that complies with release 10 (Rel-10). In this example, the evolved Node B receiver 104b and the evolved Node B transmitter 108b may receive and/or transmit using release 10 (Rel-10).

Examples of features that may be applied by the evolved Node B configuration block/module 106b include, but are not limited to uplink control information configuration, channel state information reference signal configuration, media access control configuration, data radio bearer/signal radio bearer configuration, semi-persistent scheduling (SPS) configuration, carrier aggregation configuration, channel state information reference signal configuration, downlink control information format, transmission mode nine, physical uplink shared channel multi-cluster, physical uplink shared channel configuration, physical downlink shared channel configuration and physical uplink control channel configuration. The evolved Node B transmitter 108b may send 208 a connection reconfiguration complete message uplink grant. In some implementations, the connection reconfiguration complete message uplink grant may be in a common search space. A common search space may be a search space where the configurations of different releases of a wireless communication standard may align. For example, a common search space may include a search space where the release 8 (Rel-8) and release 10 (Rel-10) configurations are more aligned. By comparison, in a user equipment search space, release 8 (Rel-8) and release 10 (Rel-10) are not as well aligned. Sending 208 a connection reconfiguration complete message uplink grant in a common search space may reduce confusion. In this example, the connection reconfiguration complete message uplink grant may allow the user equipment 102 to send the connection reconfiguration complete message.

The evolved Node B receiver 104b may receive 210 a connection reconfiguration complete message that indicates that the user equipment 102 has applied a configuration. For example, the evolved Node B receiver 104b may receive a connection reconfiguration complete message indicating that the user equipment 102 has applied the second configuration (e.g., release 10 (Rel-10)). The connection reconfiguration complete message may be received using the second configuration. An example is given as follows. The user equipment 102 may be configured according to release 8 (Rel-8) of the Long Term Evolution (LTE) standard. The connection reconfiguration message may direct the user equipment 102 to apply a release 10 (Rel-10) configuration (e.g., rate matching around a channel state information reference signal). In some implementations, rate matching may include prioritizing information channels in a transmission. For example, a channel state information reference signal may have higher priority than a physical downlink shared channel. In this example, the channel state information reference signal may occupy a resource element first and the physical downlink shared channel may fill in the other elements. In this example the connection reconfiguration complete message may be received using release 10 (Rel-10).

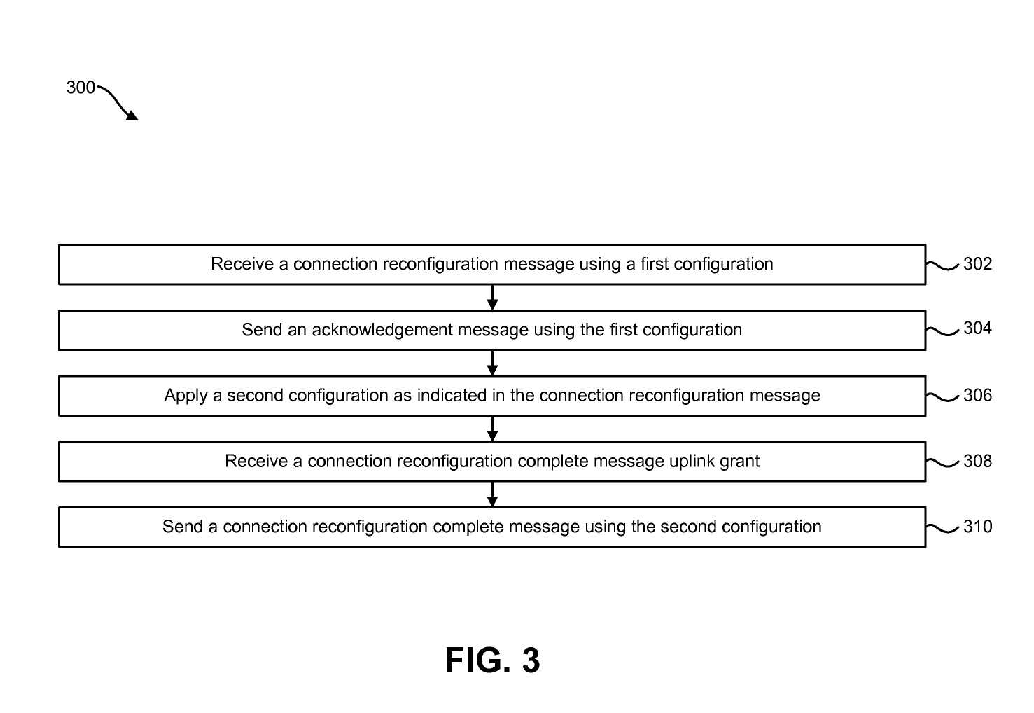

FIG. 3 is a flow diagram illustrating another configuration of a method 300 for synchronizing wireless communication device configurations. The method 300 may be performed by the user equipment 102. The user equipment receiver 104a may receive 302 a connection reconfiguration message, the connection reconfiguration message being in a first configuration. For example, the user equipment receiver 104a may receive 302 a connection reconfiguration message (e.g., an RRCConnectionReconfiguration message) from the evolved Node B 102b.

The connection reconfiguration message may direct the user equipment 102 to apply a configuration that complies with a particular release of a wireless communication standard. In some implementations, the configuration (e.g., the second configuration) that the connection reconfiguration message indicates may be different from the current configuration of the user equipment 102 (e.g., the first configuration). For example, the user equipment 102 may be configured as indicated in release 8 (Rel-8) of the Long Term Evolution (LTE) standard. In this example, the user equipment receiver 104a may receive 302 the connection reconfiguration message, the connection reconfiguration message using release 8 (Rel-8).

Examples of features of a configuration that the connection reconfiguration message may direct the user equipment 102 to alter include uplink control information configuration, channel state information reference signal configuration, media access control configuration, data radio bearer/signal radio bearer configuration, semi-persistent scheduling (SPS) configuration, carrier aggregation configuration, channel state information reference signal configuration, downlink control information format, transmission mode nine, physical uplink shared channel multi-cluster, physical uplink shared channel configuration, physical downlink shared channel configuration and physical uplink control channel configuration.

The user equipment transmitter 108a may send 304 an acknowledgement message using the first configuration. The acknowledgement message may indicate that the user equipment 102 has received a message. For example, the user equipment transmitter 108a may send 304 an acknowledgement message indicating that the user equipment 102 has received the connection reconfiguration message. In some implementations, the user equipment 102 may send 304 the acknowledgement message using a particular release of a standard. For example, if the user equipment 102 is using release 8 (Rel-8) of the Long Term Evolution (LTE) standard, the user equipment transmitter 108a may send 304 an acknowledgement message using release 8 (Rel-8).

The user equipment transmitter 108a may send the acknowledgement message from one or more layers of the user equipment 102. For example, the user equipment transmitter 108a may send a physical layer acknowledgement message. Similarly, the user equipment transmitter 108a may send a radio link control layer acknowledgement message. In some implementations, the user equipment transmitter 108a may transmit the acknowledgement message using the first configuration.

The user equipment configuration block/module 106a may apply 306 a second configuration using the connection reconfiguration message. For example, the user equipment configuration block/module 106a may apply 306 a second configuration when it has received a connection reconfiguration message from the evolved Node B 124. In this example, the user equipment configuration block/module 106a may apply the configuration indicated in the connection reconfiguration message. In some implementations, the second configuration may be release 10 (Rel-10).

Applying 306 a second configuration may include receiving and/or transmitting using the second configuration. In this implementation, the user equipment receiver 104a and the user equipment transmitter 108a may receive and/or transmit using the configuration applied by the user equipment configuration block/module 106a. For example, the user equipment configuration block/module 106a may apply a configuration to the user equipment 102 that complies with release 10 (Rel-10). In this example, the user equipment receiver 104a and the user equipment transmitter 108a may receive and/or transmit using release 10 (Rel-10).

In some implementations, the user equipment receiver 104a may receive 308 a connection reconfiguration complete message uplink grant. In some implementations, the connection reconfiguration complete message uplink grant may be in a common search space. For example, the user equipment 102 may receive 308 a connection reconfiguration complete message uplink grant from the evolved Node B 124. In this example, the user equipment 102 may use the connection reconfiguration complete message uplink grant to send the connection reconfiguration complete message.

The user equipment transmitter 108a may send 310 a connection reconfiguration complete message using the second configuration. For example, the user equipment receiver 104a may send 310 a connection reconfiguration complete message indicating that the user equipment 102 has applied the second configuration (e.g., release 10 (Rel-10)). As described above, the connection reconfiguration complete message may be in a second configuration. For example the user equipment 102 may be configured as indicated in release 8 (Rel-8) of the Long Term Evolution (LTE) standard. The connection reconfiguration message may direct the user equipment 102 to implement a release 10 (Rel-10) configuration (e.g., rate matching around a channel state information reference signal). The connection reconfiguration complete message may be in release 10 (Rel-10). In some implementations, the user equipment transmitter 108a may temporarily delay sending the connection reconfiguration complete message for a determined period of time after the user equipment configuration block/module 106a has applied the configuration. For example, the user equipment transmitter 108a may delay at least one sub-frame before sending 310 the connection reconfiguration complete message.

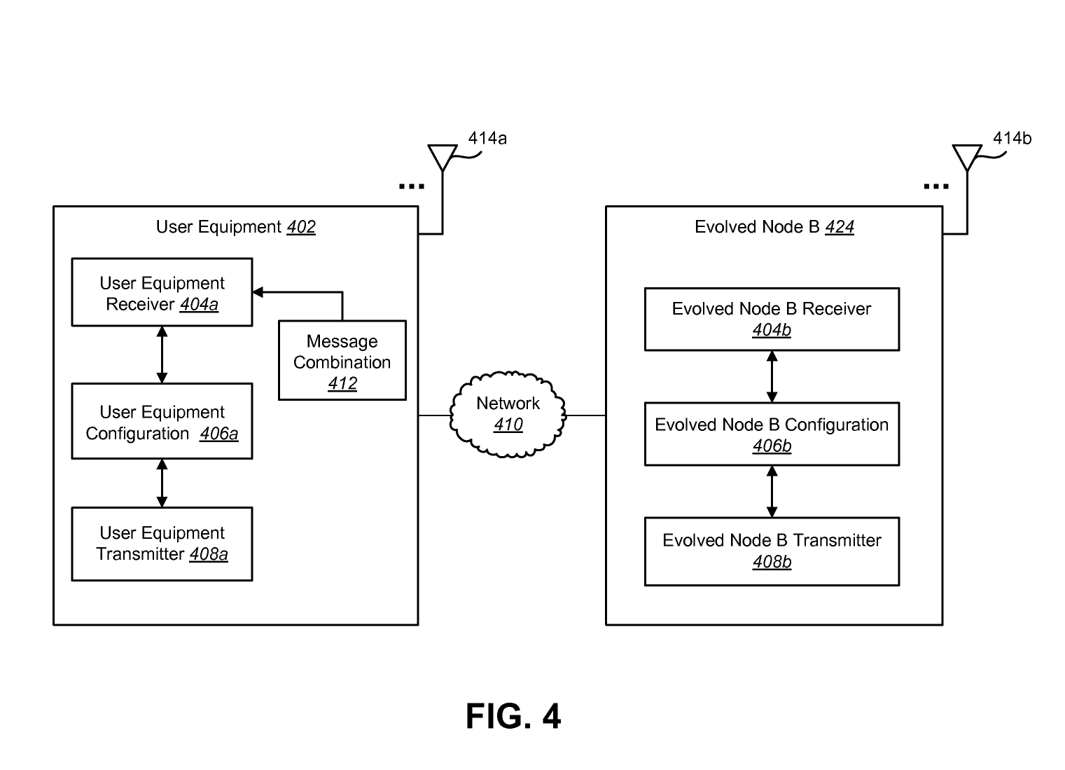

FIG. 4 is a block diagram illustrating another configuration of a user equipment 402 and an evolved Node B 424 in which systems and methods for synchronizing wireless communication device configurations may be implemented. In some implementations, the user equipment 402 may be an example of the user equipment 102 described in connection with FIG. 1. Similarly, the evolved Node B 424 may be an example of the evolved Node B 124 described in connection with FIG. 1. The user equipment 402 and the evolved Node B 424 may include antennas 414a-b, a receiver 404a-b, a configuration block/module 406a-b and/or a transmitter 408a-b that may be examples of corresponding elements described in connection with FIG. 1. The user equipment 402 and the evolved Node B 424 may communicate with one another via a radio access network 410 that may be an example of the radio access network 110 described in connection with FIG. 1.

In some implementations, the user equipment 402 may include a message combination block/module 412. The message combination block/module 412 may be coupled to the user equipment receiver 404a. The message combination block/module 412 may combine a plurality of received messages. In some implementations, the message combination block/module 412 may combine versions of a message that correspond to different releases of a standard. For example, the user equipment receiver 404a may receive a first message using release 8 (Rel-8). The user equipment receiver 404a may then receive a second message (with the same content) using release 10 (Rel-10). In this example, the message combination block/module 412 may combine the messages to form a single message. In some implementations, the message combination block/module 412 may combine messages in this fashion until the user equipment 402 sends a connection reconfiguration complete message.

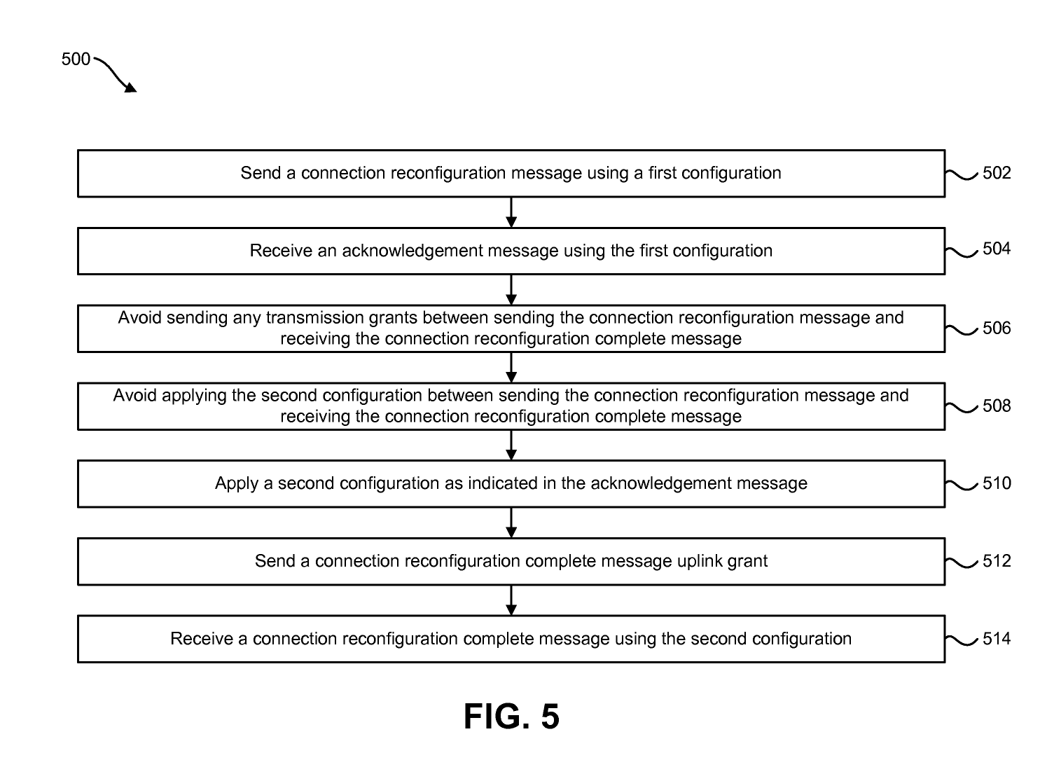

FIG. 5 is a flow diagram illustrating another configuration of a method 500 for synchronizing wireless communication device configurations. The method 500 may be performed by the evolved Node B 424. The evolved Node B transmitter 408b may send 502 a connection reconfiguration message using a first configuration. In some implementations, this may be done as described in connection with FIG. 2.

The evolved Node B receiver 404b may receive 504 an acknowledgement message in the first configuration. In some implementations, this may be done as described in connection with FIG. 2.

The evolved Node B 424 may avoid 506 sending transmission grants between sending the connection reconfiguration message and receiving the connection reconfiguration complete message. For example, after sending 502 a connection reconfiguration message, the evolved Node B transmitter 408b may avoid 506 sending any transmission grants (e.g., downlink grant and uplink grant). In this example, the evolved Node B transmitter 408b may resume sending transmission grants when the connection reconfiguration complete message has been received.

The evolved Node B configuration block/module 406b may avoid 508 applying a second configuration to the evolved Node B 424. For example, the evolved Node B configuration block/module 406b may avoid applying a configuration to the evolved Node B 424 for the period between sending the connection reconfiguration message and receiving the connection reconfiguration complete message.

The evolved Node B configuration block/module 406b may apply 510 a second configuration as indicated in the acknowledgement message. In some implementations, this may be done as described in connection with FIG. 2.

The evolved Node B transmitter 408b may send 512 a connection reconfiguration complete message uplink grant. In some implementations, this may be done as described in connection with FIG. 2.

The evolved Node B receiver 404b may receive 514 a connection reconfiguration complete message, the reconfiguration complete message being in the second configuration. In some implementations, this may be done as described in connection with FIG. 2.

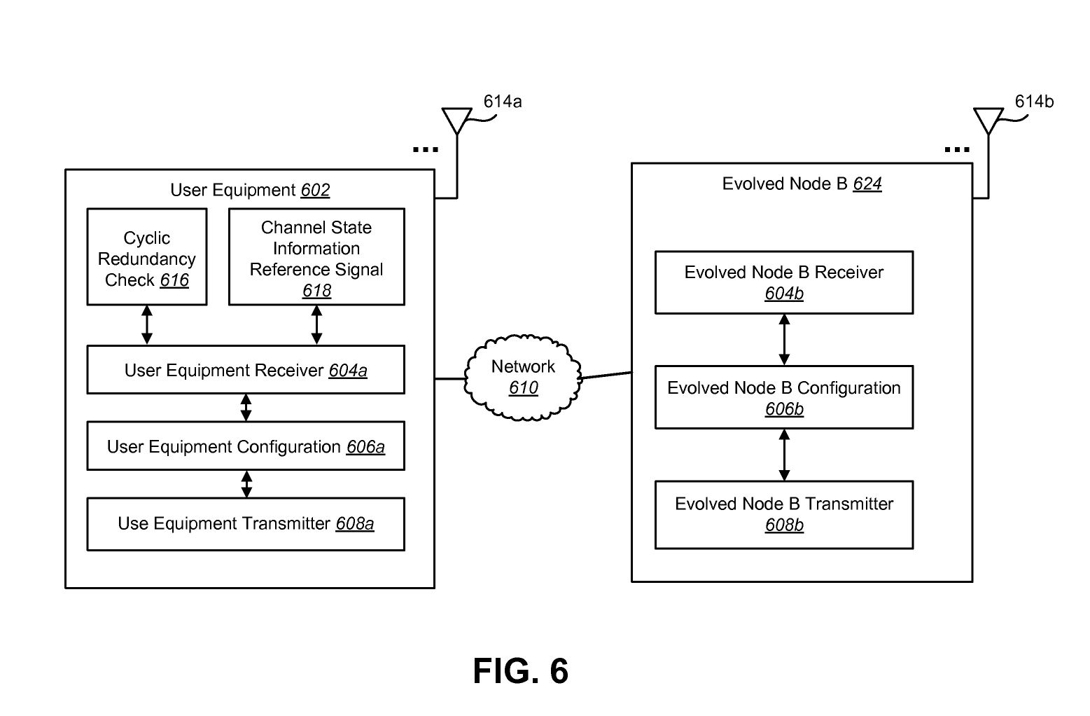

FIG. 6 is a block diagram illustrating another configuration of a user equipment 602 and an evolved Node B 624 in which systems and methods for synchronizing wireless communication device configurations may be implemented. In some implementations, the user equipment 602 and the evolved Node B 624 may be examples of corresponding elements described in connection with FIG. 1. The user equipment 602 and the evolved Node B 624 may include one or more antennas 614a-b, a receiver 604a-b, a configuration block/module 606a-b, and a transmitter 608a-b that may be examples of corresponding elements described in connection with FIG. 1. The user equipment 602 and the evolved Node B 624 may communicate with one another via a radio access network 610 similar to the radio access network 110 described in connection with FIG. 1.

The user equipment 602 may include a channel state information reference signal block/module 618. In some implementations, the channel state information reference signal block/module 618 may be coupled to the user equipment receiver 604a. In this implementation, the channel state information reference signal block/module 618 may detect whether a sub-frame of a message includes a channel state information reference signal. If a sub-frame of a message does not have a channel state information reference signal, the channel state information reference signal block/module 618 may so indicate to the user equipment receiver 604a. In this example, the user equipment receiver 604a may process the sub-frame using the user equipment's 602 current configuration. By comparison, if the sub-frame of a message does have a channel state information reference signal, the channel state information reference signal block/module 618 may so indicate to the user equipment receiver 604a. In this example, the user equipment receiver 604a may process the sub-frame differently, as will be described in greater detail below.

The user equipment 602 may include a cyclic redundancy check block/module 616. The cyclic redundancy check block/module 616 may perform a cyclic redundancy check. For example, the cyclic redundancy check block/module 616 may perform a cyclic redundancy check of a physical downlink shared channel. The cyclic redundancy check block/module 616 may determine if the physical downlink shared channel cyclic redundancy check passes. The cyclic redundancy check may be a parity check. For example, evolved Node B 624 may send a one-bit cyclic redundancy check bit that represents an even number of ones in an information bit string. For example, if the evolved Node B 624 identifies an even number of ones in the information bit string, the evolved Node B 624 may set the one-bit cyclic redundancy bit to one. In this example, the user equipment 602 may receive the information bit string and the one-bit cyclic redundancy check bit. The user equipment 602 may also count the number of ones in an information bit string. If the user equipment 602 counts an even number of ones in the information bit string, the user equipment 602 may assume the cyclic redundancy check passes. If the user equipment 602 counts an odd number of ones in an information bit string, the user equipment 602 may assume the payload is wrong. In LTE, a 24-bit cyclic redundancy check may be used for each code block and transport block.

In some implementations, the cyclic redundancy check block/module 616 may be coupled to the user equipment receiver 604a. If the cyclic redundancy check block/module 616 determines that a cyclic redundancy check passes, the cyclic redundancy check block/module 616 may so indicate to the user equipment receiver 604a. Similarly, if the cyclic redundancy check block/module 616 determines that a cyclic redundancy check does not pass, the cyclic redundancy check block/module 616 may so indicate to the user equipment receiver 604a.

Using the information from the cyclic redundancy check block/module 616, the use equipment receiver 604a may process the sub-frame. For example, if the channel state information reference signal block/module 618 indicates that a channel state information reference signal is present in a sub-frame and the cyclic redundancy check block/module 616 indicates that a cyclic redundancy check has passed, the user equipment 602 may confirm that it is configured according to the second configuration (e.g., the configuration indicated in the connection reconfiguration message).

Alternatively, if the channel state information reference signal block/module 618 indicates that a channel state information reference signal is present in a sub-frame and the cyclic redundancy check block/module 616 indicates that a cyclic redundancy check has not passed, the user equipment 602 may discard the sub-frame. In another implementation, if the channel state information reference signal block/module 618 indicates that a channel state information reference signal is present in a sub-frame and the cyclic redundancy check block/module 616 indicates that a cyclic redundancy check has not passed, the user equipment 602 may perform a hypothesis. As used herein the term “hypothesis” may refer to soft-combining the sub-frame and not soft-combining the sub-frame. An example of performing a hypothesis is given as follows. The evolved Node B 624 may have multiple configurations through which to send information to a user equipment 602. In this example, the user equipment 602 may not recognize which configuration the evolved Node B 624 used. The user equipment 602 may receive the information according to the multiple configurations. Whichever format allows the user equipment 602 to successfully receive the information is the correct transmission configuration. For example, a user equipment 602 may not recognize whether to rate match around a channel state information reference signal. In this example, the user equipment 602 may both rate match around the channel state information signal and not rate match around the channel state information signal and identify which format allows the user equipment 602 to successfully receive the information.

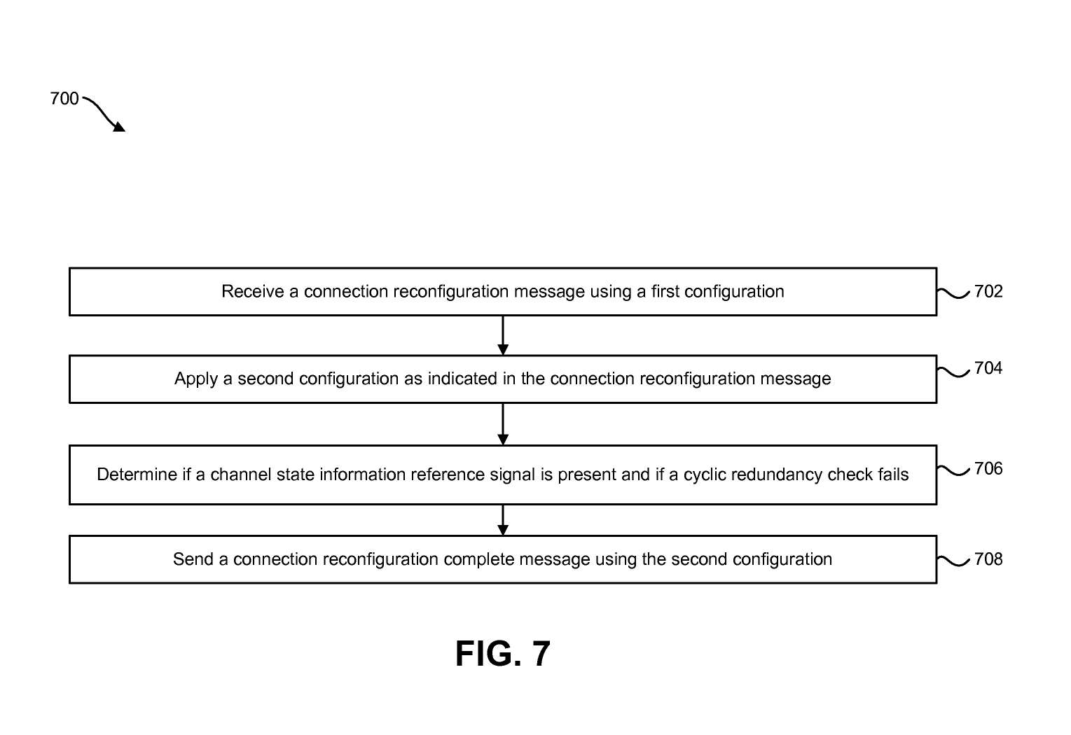

FIG. 7 is a flow diagram illustrating another configuration of a method 700 for synchronizing wireless communication device configurations. The method 700 may be performed by the user equipment 602. The user equipment 602 may receive 702 a connection reconfiguration message, the connection reconfiguration message being in a first configuration. In some implementations, this may be done as described in connection with FIG. 3.

The user equipment configuration block/module 606a may apply 704 a second configuration as indicated in the connection reconfiguration message. In some implementations, this may be done as described in connection with FIG. 3.

The user equipment 602 may determine 706 if a channel state information reference signal is present and if a cyclic redundancy check fails. More specifically, the channel state information reference signal block/module 618 may determine if a channel state information reference signal is present in a sub-frame of a message. In this example, the channel state information reference signal block/module 618 may indicate to the user equipment receiver 604a whether or not a channel state information reference signal is present in a sub-frame of a message.

Similarly, the cyclic redundancy check block/module 616 may determine if a cyclic redundancy check fails. For example, the cyclic redundancy check block/module 616 may perform a cyclic redundancy check of a physical downlink shared channel. The cyclic redundancy check block/module 616 may determine if the cyclic redundancy check fails. As described above, the cyclic redundancy check block/module 616 may indicate to the user equipment receiver 604a whether or not the cyclic redundancy check fails.

The user equipment transmitter 608a may send 708 a connection reconfiguration complete message using the second configuration. In some implementations, this may be performed as described in connection with FIG. 3.

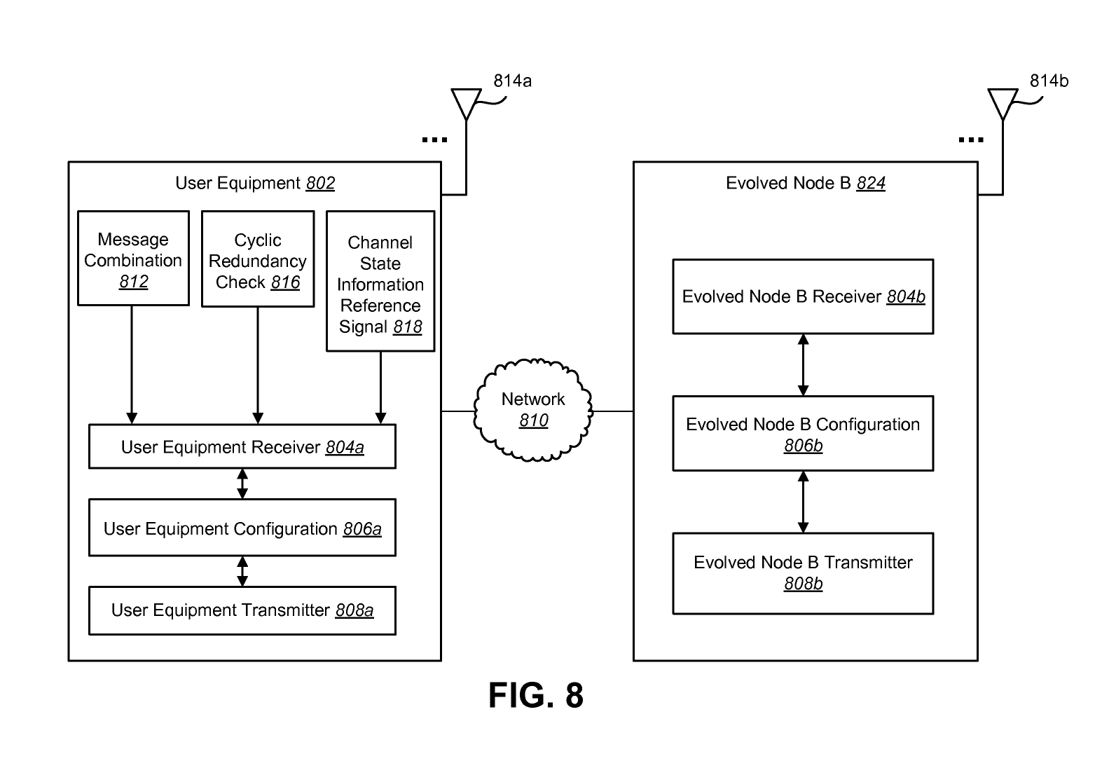

FIG. 8 is a block diagram illustrating another configuration of a user equipment 802 and an evolved Node B 824 in which systems and methods for synchronizing wireless communication device configurations may be implemented. The user equipment 802 and the evolved Node B 824 may be examples of corresponding elements described in connection with FIG. 1. The user equipment 802 and the evolved Node B 824 may include a receiver 804a-b, a configuration block/module 806a-b, a transmitter 808a-b and/or an antenna 814a-b that may be examples of corresponding elements described earlier. Moreover, the user equipment 802 may include a message combination block/module 812, a cyclic redundancy check block/module 816 and/or a channel state information reference signal block/module 818 that may be examples of corresponding elements described earlier. The user equipment 802 and the evolved Node B 824 may communicate with one another via a radio access network 810 similar to the radio access network 110 described in connection with FIG. 1.

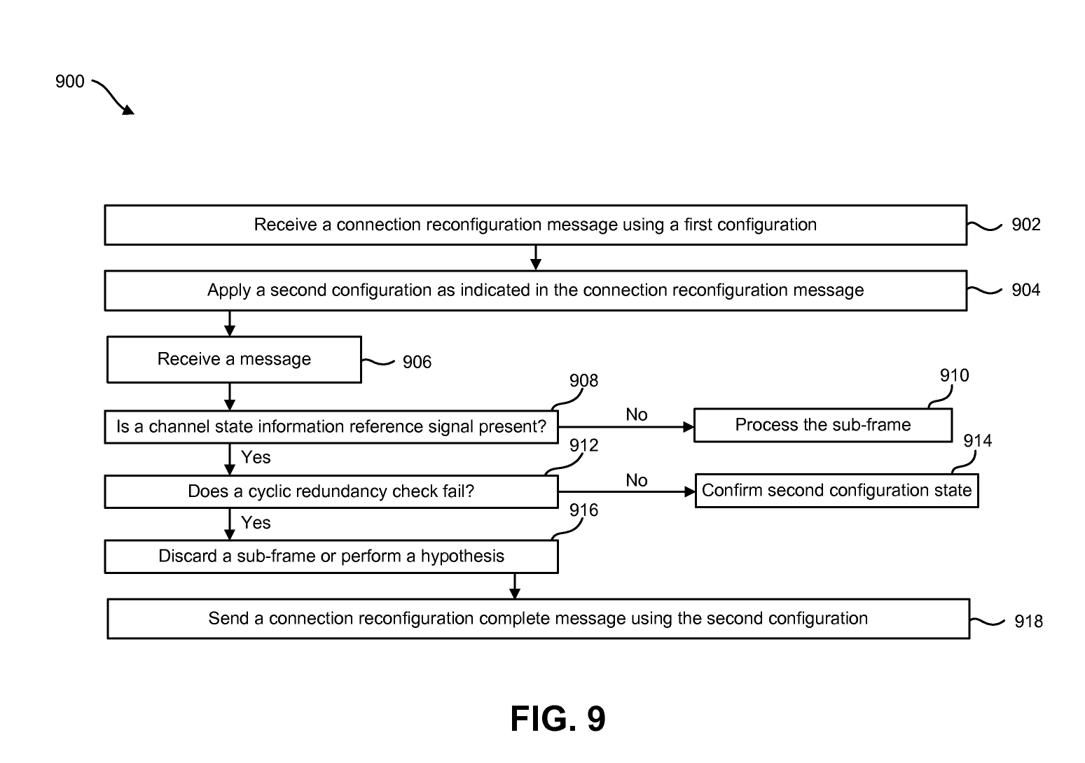

FIG. 9 is a flow diagram illustrating another configuration of a method 900 for synchronizing wireless communication device configurations. The method may be performed by the user equipment 802. The user equipment 802 may receive 902 a connection reconfiguration message, the connection reconfiguration message being in a first configuration. In some implementations, this may be done as described in connection with FIG. 3.

The user equipment configuration block/module 806a may apply 904 a second configuration as indicated in the connection reconfiguration message. In some implementations this may be done as described in connection with FIG. 3.

In some implementations, the user equipment receiver 804a may receive 906 a message. For example, the user equipment receiver 804a may receive 906 a message after applying 904 the second configuration. In this implementation, the channel state information reference signal block/module 818 may determine 908 if a channel state information reference signal is present in a sub-frame of a message. If the channel state information reference signal block/module 818 determines 908 that a channel state information reference signal is not present in a sub-frame of a message, the user equipment 802 may process 910 the received sub-frame. In some implementations, the user equipment 802 may process 910 the received sub-frame using the user equipment's 802 configuration (e.g., release 8 (Rel-8)).

If the channel state information reference signal block/module 818 determines 908 that a channel state information reference signal is present in a sub-frame of a message, the cyclic redundancy check block/module 816 may determine 912 if a cyclic redundancy check fails. If the cyclic redundancy check block/module 816 determines 912 that a cyclic redundancy check does not fail, the user equipment 802 may confirm 914 a second configuration (e.g., release 10 (Rel-10)) state. If the cyclic redundancy check block/module 816 determines 912 that a cyclic redundancy check does fail, the user equipment 802 may discard 916 the sub-frame or perform a hypothesis on the sub-frame. As described above performing a hypothesis may include combining the sub-frame and avoiding combining the sub-frame.

The user equipment transmitter 808a may send 918 a connection reconfiguration complete message using a second configuration. In some implementations, this may be done as described in connection with FIG. 3.

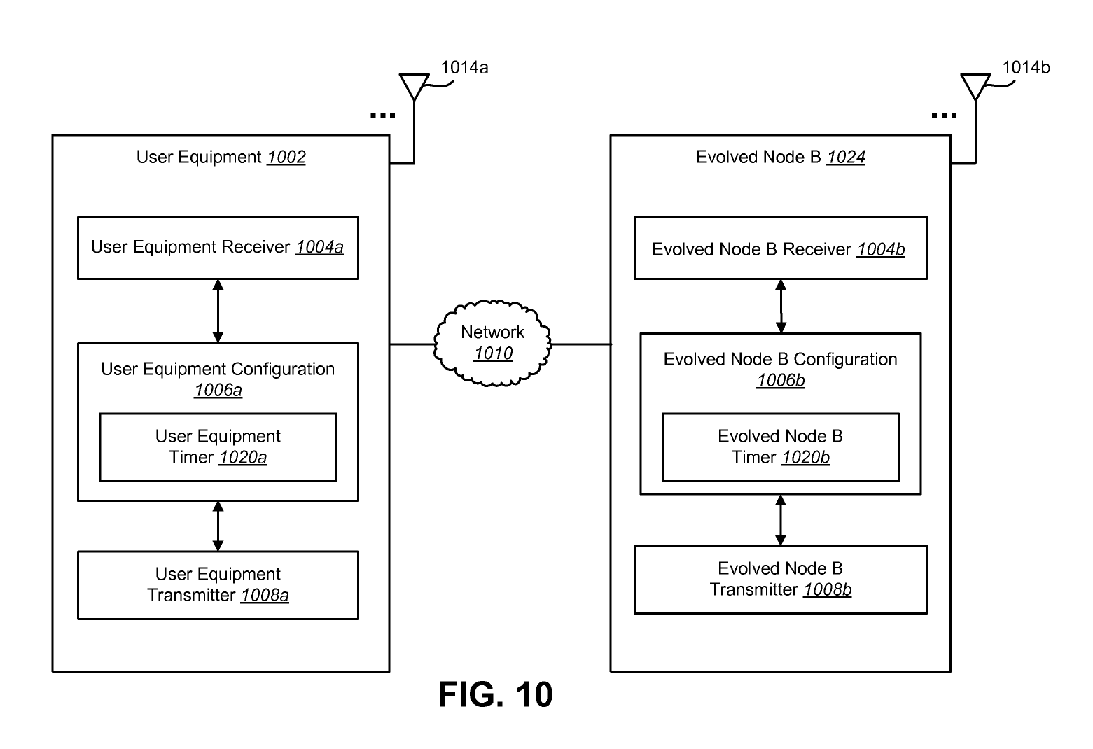

FIG. 10 is a block diagram illustrating another configuration of a user equipment 1002 and an evolved Node B 1024 in which systems and methods for synchronizing wireless communication device configurations may be implemented. The user equipment 1002 and the evolved Node B 1024 may be examples of corresponding elements described in connection with FIG. 1. The user equipment 1002 and the evolved Node B 1024 may include a receiver 1004a-b, a configuration block/module 1006a-b, a transmitter 1008a-b and/or an antenna 1014a-b that may be examples of corresponding elements described earlier. The 10 user equipment 1002 and the evolved Node B 1024 may communicate with one another via a radio access network 1010 similar to the radio access network 110 described in connection with FIG. 1.

In some implementations, a user equipment timer 1020a may be coupled to the user equipment configuration block/module 1006a. The user equipment timer 1020a may determine when to apply the second configuration to the user equipment 1002. More specifically, the user equipment configuration block/module 1006a may apply the second configuration to the user equipment 1002 after a determined period of time, as indicated by the user equipment timer 1020a. In some configurations, the determined period of time may depend on a division duplexing configuration. For example, the determined period of time may depend on one or more of a frequency-division duplexing configuration and a time-division duplexing configuration. In some cases, the determined period of time may be indicated in the connection reconfiguration message. Additionally or alternatively, the determined period of time may be indicated in the connection reconfiguration complete message.

Similarly, an evolved Node B timer 1020b may be coupled to the evolved Node B configuration block/module 1006b. The evolved Node B timer 1020b may determine when to apply the second configuration to the evolved Node B 1024. More specifically, the evolved Node B configuration block/module 1006b may apply the second configuration to the evolved Node B 1024 after a determined period of time, as indicated by the evolved Node B timer 1020b. In some configurations, the determined period of time may depend on a division duplexing configuration. For example, the determined period of time may depend on one or more of a frequency-division duplexing configuration and a time-division duplexing configuration. In some cases, the determined period of time may be indicated in the connection reconfiguration message. Additionally or alternatively, the determined period of time may be indicated in the connection reconfiguration complete message.

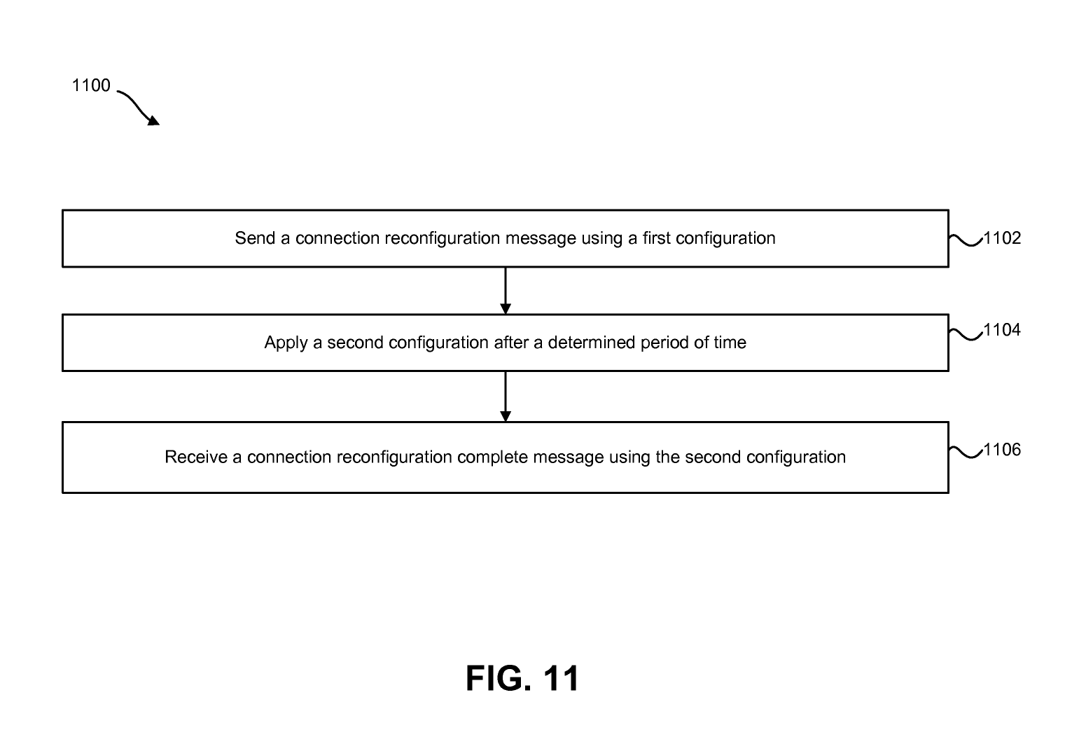

FIG. 11 is a flow diagram illustrating another configuration of a method 1100 for synchronizing wireless communication device configurations. The method 1100 may be performed by the evolved Node B 1024. The evolved Node B transmitter 1008b may send 1102 a connection reconfiguration message using a first configuration. In some implementations, this may be done as described in connection with FIG. 2.

The evolved Node B configuration block/module 1006b may apply 1104 a second configuration after a determined period of time. In some implementations, the determined period of time may be indicated by the evolved Node B timer 1020b. For example, the evolved Node B timer 1020b coupled to the evolved Node B configuration block/module 1006b may indicate the determined period of time after which the evolved Node B configuration block/module 1006b may apply the second configuration. In some configurations, the determined period of time may be based on a division duplexing configuration. For example, the determined period of time may depend on one or more of a frequency-division duplexing configuration and a time-division duplexing configuration. In some cases, the determined period of time may be indicated in the connection reconfiguration message. Additionally or alternatively, the determined period of time may be indicated in the connection reconfiguration complete message.

In some implementations, applying 1104 a second configuration may include using a media access control header element to trigger the application of the second configuration (e.g., release 10 (Rel-10)). For example a media access controller (MAC) may contain a media access control header element for release 10 (Rel-10) activation. In some implementations, the evolved Node B 1024 may start the release 10 (Rel-10) a determined period of time (e.g., 8 milliseconds) after this MAC packet's corresponding time stamp (e.g., SFN/SUBFRAME). In other words, the MACK packet may be sent at system frame number (SFN) x, subframe y. In this example the evolved Node B 1024 may start release 10 (Rel-10) at the system frame number x*10+y+8, subframe x*10+y+8% 10. Applying 1104 a second configuration may also include using a physical layer downlink control indicator to trigger the application of the second configuration (e.g., release 10 (Rel-10)).

The evolved Node B receiver 1004b may receive 1106 a connection reconfiguration complete message using the second configuration. In some implementations, this may be done as described in connection with FIG. 2.

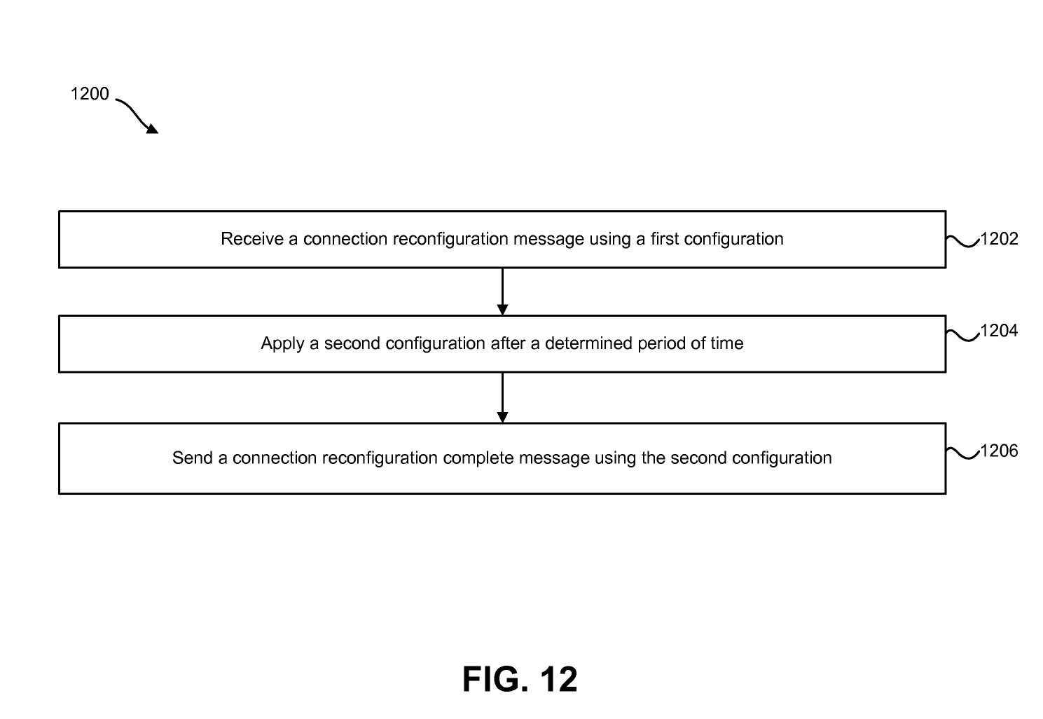

FIG. 12 is a flow diagram illustrating another configuration of a method 1200 for synchronizing wireless communication device configurations. The method 1200 may be performed by the user equipment 1002. The user equipment transmitter 1008a may receive 1202 a connection reconfiguration message using a first configuration. In some implementations, this may be done as described in connection with FIG. 3.

The user equipment configuration block/module 1006a may apply 1204 a second configuration after a determined period of time. In some implementations, the determined period of time may be indicated by the user equipment timer 1020a. For example, the user equipment timer 1020a, coupled to the user equipment configuration block/module 1006a, may indicate the determined period of time after which the user equipment configuration block/module 1006a may apply the second configuration. In some configurations, the determined period of time may be based on a division duplexing configuration. For example, the determined period of time may depend on one or more of a frequency-division duplexing configuration and a time-division duplexing configuration. In some cases, the determined period of time may be indicated in the connection reconfiguration message. Additionally or alternatively, the determined period of time may be indicated in the connection reconfiguration complete message.

In some implementations, applying 1204 a second configuration may include using a media access control header element to trigger the application of the second configuration (e.g., release 10 (Rel-10)). Applying 1204 a second configuration may also include using a physical layer downlink control indicator to trigger the application of the second configuration (e.g., release 10 (Rel-10)).

The user equipment receiver 1004a may send 1206 a connection reconfiguration complete message using the second configuration. In some implementations, this may be done as described in connection with FIG. 3.

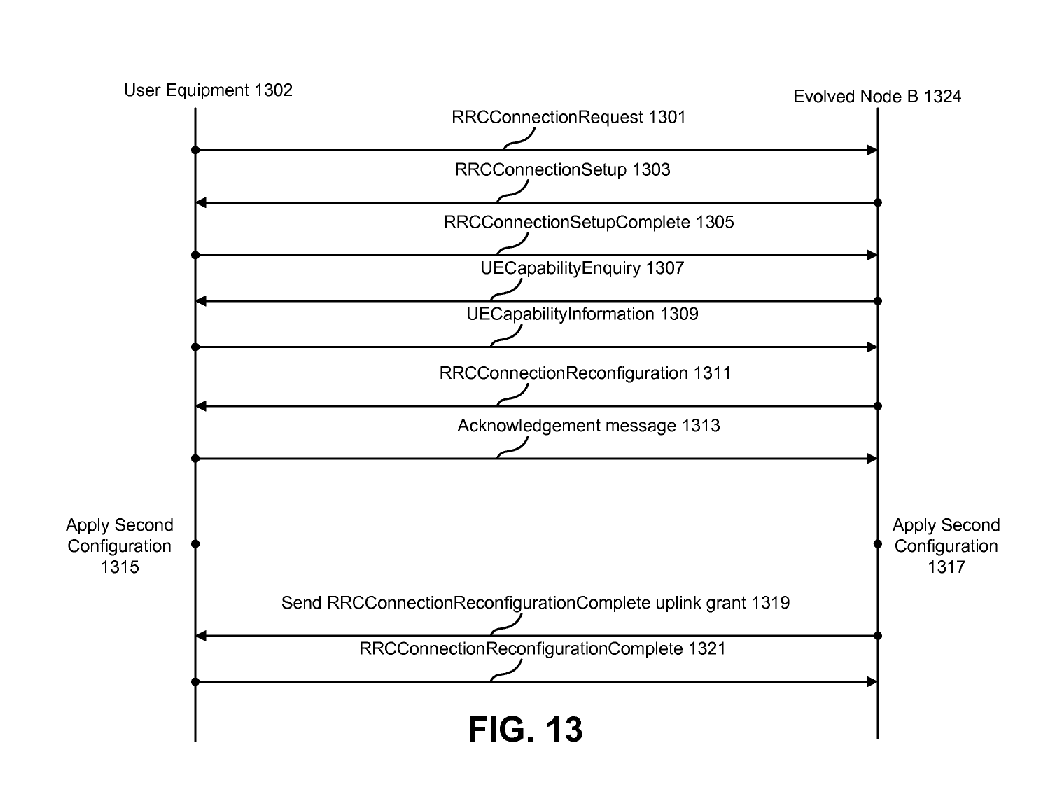

FIG. 13 is a thread diagram illustrating one configuration of a user equipment 1302 and an evolved Node B 1324 in which systems and methods for synchronizing wireless communication device configurations may be implemented. In some implementations, the user equipment 1302 may be an example of the user equipment 102 described in connection with FIG. 1. Similarly, the evolved Node B 1324 may be an example of the evolved Node B 124 described in connection with FIG. 1. As described in connection with FIG. 13, the user equipment 1302 and the evolved Node B 1324 may transmit one or more message to establish a wireless connection. The user equipment 1302 may send 1301 an RRCConnectionRequest message to the evolved Node B 1324. This message may request a wireless connection with the evolved Node B 1324. The evolved Node B 1324 may send 1303 an RRCConnectionSetup message. Once the user equipment 1302 has completed the connection setup, the user equipment 1302 may send 1305 an RRCConnectionSetupComplete message to the evolved Node B 1324 indicating the user equipment 1302 has completed the setup procedure.

In some configurations, if the user equipment 1302 and/or the evolved Node B 1324 may transition from a first configuration (e.g., release 8 (Rel-8)) to a second configuration (e.g., release 10 (Rel-10)). In this configuration, the evolved Node B 1324 may send 1307 a UECapabilityEnquiry message. In some examples, the UECapabilityEnquiry message may direct the user equipment 1302 to acknowledge whether it supports the second configuration (e.g., release 10 (Rel-10)). In response, the user equipment 1302 may reply 1309 with a UECapabilityInformation message. The UECapabilityInformation message may indicate to the evolved Node B 1324 that the user equipment 1302 does support the second configuration (e.g., release 10 (Rel-10)). If the user equipment 1302 does support the second configuration, the evolved Node B 1324 may send 1311 an RRCConnectionReconfiguration message. As described above, the RRCConnectionReconfiguration message may be an example of the connection reconfiguration message described earlier. More particularly, the RRCConnectionReconfiguration message may be sent using the first configuration. In response, the user equipment 1302 may send 1313 an acknowledgement message indicating it has received the RRCConnectionReconfiguration message. The acknowledgement message may be sent using the first configuration. At this stage, the user equipment 1302 may apply 1315 the second configuration. Similarly, the evolved Node B 1324 may apply 1317 the second configuration. The evolved Node B 1324 may send 1319 an RRCConnectionReconfigurationComplete message uplink grant. In some implementations, the RRCConnectionReconfigurationComplete message uplink grant may be an example of the connection reconfiguration message uplink grant described earlier. Using the RRCConnectionReconfigurationComplete message uplink grant, the user equipment 1302 may send 1321 an RRCConnectionReconfigurationComplete message. In some implementations, the RRCConnectionReconfigurationComplete message may be an example of the connection reconfiguration complete message described earlier.

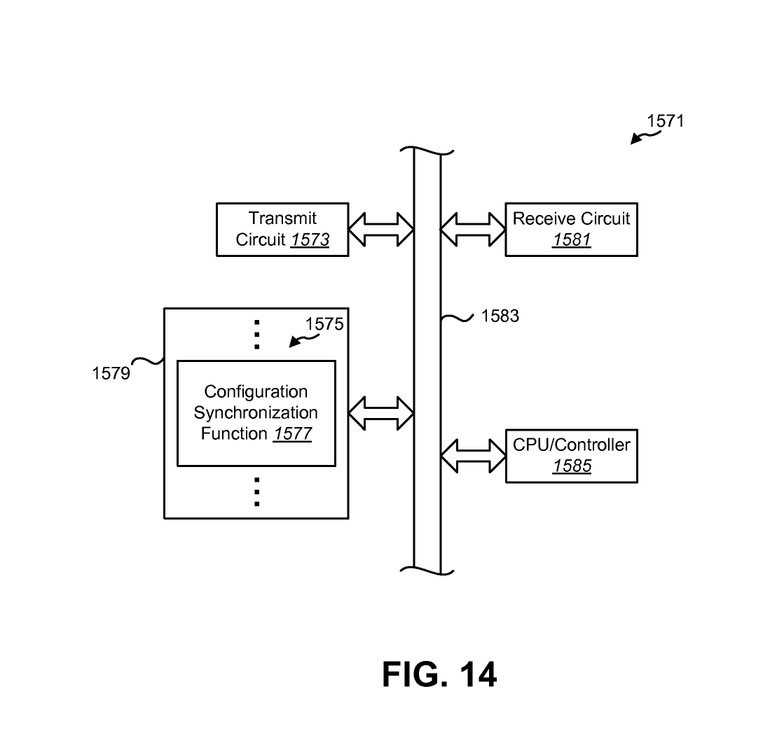

FIG. 14 shows part of a hardware implementation of an apparatus 1571 for executing the schemes or processes as described above. The apparatus 1571 comprises circuitry as described below. In this specification and the appended claims, it should be clear that the term “circuitry” is construed as a structural term and not as a functional term. For example, circuitry can be an aggregate of circuit components, such as a multiplicity of integrated circuit components, in the form of processing and/or memory cells, units, blocks and the like, such as shown and described in FIG. 14.

In this embodiment, the circuit apparatus is signified by the reference numeral 1571 and can be implemented in any of the communication entities described herein, such as the user equipment, 102, 402, 602, 802, 1002 and 1302 and the evolved Node B 124, 424, 624, 824, 1024 and 1324.

The apparatus 1571 comprises a central data bus 1583 linking several circuits together. The circuits include a CPU (Central Processing Unit) or a controller 1585, a receive circuit 1581, a transmit circuit 1573, and a memory unit 1579.

If the apparatus 1571 is part of a wireless device, the receive circuit 1581 and the transmit circuit 1573 can be connected to an RF (radio frequency) circuit (which is not shown in the drawing). The receive circuit 1581 processes and buffers received signals before sending the signals out to the data bus 1583. On the other hand, the transmit circuit 1573 processes and buffers the data from the data bus 1583 before sending the data out of the device 1571. The CPU/controller 1585 performs the function of data management of the data bus 1583 and furthers the function of general data processing, including executing the instructional contents of the memory unit 1579.

The memory unit 1579 includes a set of modules and/or instructions generally signified by the reference numeral 1575. In this embodiment, the modules/instructions include, among other things, a configuration synchronization function 1577 which carries out the schemes and processes as described above. The function 1577 includes computer instructions or code for executing the process steps as shown and described in FIGS. 1-13. Specific instructions particular to an entity can be selectively implemented in the function 1577. For instance, if the apparatus 1571 is part of a user equipment 102, 402, 602, 802, 1002 or 1302 or the evolved Node B 124, 424, 624, 824, 1024 or 1324, among other things, instructions particular to the user equipment 102, 402, 602, 802, 1002 or 1302 or the evolved Node B 124, 424, 624, 824, 1024 or 1324, as shown and described in FIGS. 1-13 can be coded in the function 1577.

In this embodiment, the memory unit 1579 is a RAM (Random Access Memory) circuit. The exemplary functions, such as the function 1577, include one or more software routines, modules and/or data sets. The memory unit 1579 can be tied to another memory circuit (not shown) which either can be of the volatile or nonvolatile type. As an alternative, the memory unit 1579 can be made of other circuit types, such as an EEPROM (Electrically Erasable Programmable Read Only Memory), an EPROM (Electrical Programmable Read Only Memory), a ROM (Read Only Memory), an ASIC (Application Specific Integrated Circuit), a magnetic disk, an optical disk, and others well known in the art.

In the above description, reference numbers have sometimes been used in connection with various terms. Where a term is used in connection with a reference number, this may be meant to refer to a specific element that is shown in one or more of the Figures. Where a term is used without a reference number, this may be meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “couple” and any variations thereof may indicate a direct or indirect connection between elements. For example, a first element coupled to a second element may be directly connected to the second element, or indirectly connected to the second element through another element.

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer or processor. Disk and disc, as used herein, include compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL) or wireless technologies such as infrared, radio and microwave, then the coaxial cable, fiber optic cable, twisted pair, DSL or wireless technologies such as infrared, radio and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

No claim element is to be construed under the provisions of 35 U.S.C. §152, sixth paragraph, unless the element is expressly recited using the phrase “means for” or, in the case of a method claim, the element is recited using the phrase “step for.”

What is claimed is:

1. An apparatus operable by a communication system, comprising:
means for sending a connection reconfiguration message using a first configuration;
means for receiving an acknowledgement message using the first configuration;
means for applying a second configuration as indicated in the acknowledgement message;
means for sending a connection reconfiguration complete message uplink grant in a common search space; and
means for receiving a connection reconfiguration complete message using the second configuration.

2. The apparatus of claim 1, wherein the acknowledgement message is a physical layer acknowledgement message.

3. An apparatus operable in a communication system, comprising:
means for receiving a connection reconfiguration message using a first configuration;
means for sending an acknowledgement message using the first configuration;
means for applying a second configuration as indicated in the connection reconfiguration message;
means for receiving a connection reconfiguration complete message uplink grant in a common search space; and
means for sending the connection reconfiguration complete message using the second configuration.

4. The apparatus of claim 3, wherein the acknowledgement message is a physical layer acknowledgement message.

5. An apparatus operable in a communication system, comprising:
means for receiving a connection reconfiguration message using a first configuration;
means for applying a second configuration as indicated in the connection reconfiguration message;
means for determining if a channel state information reference signal is present and a cyclic redundancy check fails; and
means for sending a connection reconfiguration complete message using the second configuration.

6. The apparatus of claim 5, further comprising:
means for receiving a message after applying the second configuration; and
means for discarding a sub-frame if a channel state information reference signal is present and a cyclic redundancy check fails.

7. An apparatus operable in a communication system, comprising:
means for sending a connection reconfiguration message using a first configuration;
means for applying a second configuration after a determined period of time; and
means for receiving a connection reconfiguration complete message using the second configuration.

8. The apparatus of claim 7, wherein the determined period of time depends on a division duplexing configuration.

9. An apparatus operable in a communication system, comprising:
means for receiving a connection reconfiguration message using a first configuration;
means for applying a second configuration after a determined period of time; and
means for sending a connection reconfiguration complete message using the second configuration.

10. The apparatus of claim 9, wherein the determined period of time depends on a division duplexing configuration.

11. An apparatus, comprising:
circuitry configured to send a connection reconfiguration message using a first configuration, receive an acknowledgement message using the first configuration, apply a second configuration as indicated in the acknowledgement message, send a connection reconfiguration complete message uplink grant in a common search space, and receive a connection reconfiguration complete message using the second configuration.

12. The apparatus of claim 11, wherein the acknowledgement message is a physical layer acknowledgement message.

13. An apparatus, comprising:
circuitry configured to receive a connection reconfiguration message using a first configuration, send an acknowledgement message using the first configuration, apply a second configuration as indicated in the connection reconfiguration message, receive a connection reconfiguration complete message uplink grant in a common search space, and send the connection reconfiguration complete message using the second configuration.

14. The apparatus of claim 13, wherein the acknowledgement message is a physical layer acknowledgement message.

15. An apparatus, comprising:
circuitry configured to receive a connection reconfiguration message using a first configuration, apply a second configuration as indicated in the connection reconfiguration message, determine if a channel state information reference signal is present and a cyclic redundancy check fails, and send a connection reconfiguration complete message using the second configuration.

16. The apparatus of claim 15, further comprising circuitry configured to receive a message after applying the second configuration and discard a sub-frame if a channel state information reference signal is present and a cyclic redundancy check fails.

17. An apparatus, comprising:
circuitry configured to send a connection reconfiguration message using a first configuration, apply a second configuration after a determined period of time and receive a connection reconfiguration complete message using the second configuration.

18. The apparatus of claim 17, wherein the determined period of time depends on a division duplexing configuration.

19. An apparatus, comprising:
circuitry configured to receive a connection reconfiguration message using a first configuration, apply a second configuration after a determined period of time and send a connection reconfiguration complete message using the second configuration.

20. The apparatus of claim 19, wherein the determined period of time depends on a division duplexing configuration.

21. A method operable by an apparatus, comprising:
sending a connection reconfiguration message using a first configuration;
receiving an acknowledgement message using the first configuration;
applying a second configuration as indicated in the acknowledgement message;
sending a connection reconfiguration complete message uplink grant in a common search space; and
receiving a connection reconfiguration complete message using the second configuration.

22. The method of claim 21, wherein the acknowledgement message is a physical layer acknowledgement message.

23. A method operable in an apparatus, comprising:
receiving a connection reconfiguration message using a first configuration;
sending an acknowledgement message using the first configuration;
applying a second configuration as indicated in the connection reconfiguration message;
receiving a connection reconfiguration complete message uplink grant in a common search space; and
sending the connection reconfiguration complete message using the second configuration.

24. A method operable by an apparatus, comprising:
receiving a connection reconfiguration message using a first configuration;
applying a second configuration as indicated in the connection reconfiguration message;
determining if a channel state information reference signal is present and a cyclic redundancy check fails; and
sending a connection reconfiguration complete message using the second configuration.

25. A method operable by an apparatus, comprising:
sending a connection reconfiguration message using a first configuration;
applying a second configuration after a determined period of time; and
receiving a connection reconfiguration complete message using the second configuration.

26. A method operable by an apparatus, comprising:
receiving a connection reconfiguration message using a first configuration;
applying a second configuration after a determined period of time; and
sending a connection reconfiguration complete message using the second configuration.

27. A computer-program product operable in a communication system, the computer-program product comprising a non-transitory tangible computer-readable medium having instructions thereon, the instructions comprising:
code for causing an apparatus to send a connection reconfiguration message using a first configuration;
code for causing the apparatus to receive an acknowledgement message using the first configuration;
code for causing the apparatus to apply a second configuration as indicated in the acknowledgement message;
code for causing the apparatus to send a connection reconfiguration complete message uplink grant in a common search space; and
code for causing the apparatus to receive a connection reconfiguration complete message using the second configuration.
